(19) United States
(12) Patent Application Publication
(10) Pub. No.: US 2025/0357955 A1
(43) Pub. Date: Nov. 20, 2025

(54) REFERENCE SIGNAL ANTENNA SWITCHING FOR RADIO FREQUENCY FRONT END SYSTEMS AND METHODS

(71) Applicant: pSemi Corporation, San Diego, CA (US)

(72) Inventors: Young-Taek Lee, Seongnam City (KR); Peter Bacon, Derry, NH (US); Pushp Trikha, San Diego, CA (US)

(21) Appl. No.: 18/664,214

(22) Filed: May 14, 2024

(51) Int. Cl. H04B 1/04; H04B 1/00

(52) U.S. Cl. CPC H04B 1/0483; H04B 1/006; H04B 1/0458; H04B 2001/0408

(57) ABSTRACT

Radio-frequency front end circuitry systems and methods for efficient SRS switching are described. In one example, a circuit includes a plurality of RF signal paths and a plurality of antenna ports, each antenna port couplable to two or more of the plurality of RF signal paths, including at least one RF signal path having an RF signal filter for processing received TDD signals. The circuit further includes SRS switching circuitry coupled, directly or indirectly, between a first SRS amplifier and the at least one RF signal path having an RF signal filter, the SRS switching circuitry configurable to selectively route an SRS signal from the first SRS amplifier each of the plurality of antenna ports through the corresponding RF signal filter.

### BACKGROUND

The present disclosure relates generally to radio frequency communications systems and methods, and more particularly for example, to reference signal switching in carrier aggregation systems and methods.

Modern wireless communication systems, including cellular networks, satellite communications, broadcasting systems, and the like, typically operate through the transmission and reception of signals across multiple radio frequency (RF) bands. In cases where both time-divisional duplexing (TDD) and frequency-division duplexing (FDD) signals are used concurrently through a single antenna, maintaining low insertion loss and minimizing phase differences between the signals becomes a significant challenge in implementing RF front end circuitry.

Some advanced radio systems use multiple-input, multiple-output (MIMO) technology to multiply the capacity of a radio link by using multiple transmission and receiving antennas to exploit multipath propagation. The same MIMO architecture may also be used to improve the signal-to-noise ratio (SNR) of a radio link rather than its capacity. Operation of a radio system may require switching between signal paths (e.g., TDD and FDD signal paths, transmit and receive signal paths) coupled to each antenna, as well as switching between multiple physical antennas. To accommodate multiple frequencies and multiple protocols, a system component such as a wireless device or other user equipment (UE) may operate in accordance with a communications protocol, such as 5G NR (“5th Generation, New Radio”) or 4G LTE (“4th Generation, Long Term Evolution”) communications systems defined by the 3rd Generation Partnership Project (3GPP), which use sophisticated data structures with precise timing constraints to manage radio communications.

Some radio systems use the transmission of one or more reference signals to determine the quality of a channel. For example, in the 5G NR and 4G LTE cellular telephone systems, a Sounding Reference Signal (SRS) may be transmitted by a wireless device through multiple antennas to a network component, such as a base station (e.g., a next generation node B (“gNB”) in a 5G network) to determine signal quality information, for example, about the combined effect of multipath fading, scattering, Doppler, and power loss of the transmitted signal. Such information may be used by a base station (e.g., using channel reciprocity) to estimate the downlink channel quality in different sections of the channel bandwidth and enable uplink frequency selective scheduling to optimize link budget parameters and throughput.

As communication systems become more complex and the demand for higher data rates in existing channels increases, there is an increasing need for more robust and efficient solutions to implement RF front end switching, including improved radio-frequency front end systems capable of efficiently supporting both TDD and FDD signals with SRS switching.

### SUMMARY

Embodiments of the present disclosure include improved RF front end systems and methods for TDD-FDD carrier aggregation and SRS switching that enhance communication system performance and reliability.

In various embodiments, a circuit includes a first antenna port; a first plurality of radio frequency (RF) signal paths; first antenna switching circuitry configurable to selectively couple one or more of the first plurality of RF signal paths to the first antenna port; and sounding reference signal (SRS) switching circuitry coupled, directly or indirectly, between an SRS amplifier and one of the first plurality of RF signal paths, the SRS switching circuitry configurable to selectively route an SRS signal from the SRS amplifier to the first antenna port through one of the first plurality of RF signal paths.

In various embodiments, a method includes selectively switching, using first antenna switching circuitry, each of a first plurality of radio frequency signal paths to a first antenna port, at least one of the first plurality of RF signal paths comprising a first RF signal filter; and selectively coupling, using sounding reference signal (SRS) switching circuitry coupled, directly or indirectly, between an SRS amplifier and the first RF signal filter, an SRS transmission signal from the SRS amplifier to the first antenna port through the first RF signal filter.

In various embodiments, a circuit includes a plurality of radio frequency (RF) signal paths; a plurality of antenna ports, each antenna port couplable to one or more of the plurality of RF signal paths, including at least one RF signal path having an RF signal filter for processing received signals; and sounding reference signal (SRS) switching circuitry coupled, directly or indirectly, between an SRS amplifier and the at least one RF signal path, the SRS switching circuitry configurable to selectively route an SRS signal from the SRS amplifier to each of the plurality of antenna ports through a corresponding RF signal path.

The scope of the disclosure is defined by the claims, which are incorporated into this section by reference. A more complete understanding of embodiments of the present disclosure will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates an example wireless communications system, in accordance with one or more embodiments of the present disclosure.

FIG. 2 illustrates example switching operations of a radio-frequency front end circuit, in accordance with one or more embodiments of the present disclosure.

FIG. 3A is an example timing diagram illustrating switching scenarios, in accordance with one or more embodiments of the present disclosure.

FIG. 3B illustrates example thru switch and shunt switch timing, in accordance with one or more embodiments of the present disclosure.

FIG. 3C illustrates an example timing diagram illustrating additional switching scenarios, in accordance with one or more embodiments of the present disclosure.

FIG. 4 illustrates example switch timing sequences, in accordance with one or more embodiments of the present disclosure.

FIG. 5 illustrates example circuitry for mitigating EVM glitches during switching, in accordance with one or more embodiments of the present disclosure.

FIG. 6 illustrates an overlap circuit for mitigating EVM glitches during switching, in accordance with one or more embodiments of the present disclosure.

FIG. 7 illustrates example front end circuitry including timing control circuitry, in accordance with one or more embodiments of the present disclosure.

FIG. 8 illustrates an example switching process for switching between a TDD RX mode to a TDD TX mode, in accordance with one or more embodiments of the present disclosure.

FIG. 9 illustrates an example switching process for switching between a TDD TX mode to a TDD RX mode, in accordance with one or more embodiments of the present disclosure.

FIG. 10 illustrates an example process for configuring RF front end circuitry, in accordance with one or more embodiments of the present disclosure.

FIG. 11 illustrates an example RF front end configured for SRS switching, in accordance with one or more embodiments of the present disclosure.

FIG. 12A illustrates a switching configuration of the RF front end of FIG. 11, setting the SRS port to a first antenna signal path, in accordance with one or more embodiments of the present disclosure.

FIG. 12B illustrates a switching configuration of the RF front end of FIG. 11, setting the SRS port to a second antenna signal path, in accordance with one or more embodiments of the present disclosure.

FIG. 12C illustrates a switching configuration of the RF front end of FIG. 11, setting the SRS port to a third antenna signal path, in accordance with one or more embodiments of the present disclosure.

FIG. 12D illustrates a switching configuration of the RF front end of FIG. 11, setting the SRS port to a fourth antenna signal path, in accordance with one or more embodiments of the present disclosure.

FIG. 13A illustrates example 1T4R circuitry for efficient SRS switching implemented in two modules, in accordance with one or more embodiments of the present disclosure.

FIG. 13B illustrates example 2T4R front end circuitry for efficient SRS switching implemented in two modules, in accordance with one or more embodiments of the present disclosure.

FIG. 13C illustrates example 2T4R circuitry 1370 implemented in two modules, in accordance with one or more embodiments of the present disclosure.

FIG. 14 illustrates an example process for SRS switching in front end circuitry, in accordance with one or more embodiments of the present disclosure.

Embodiments of the present disclosure and their advantages are best understood by referring to the detailed description that follows. It is noted that sizes of various components and distances between these components are not drawn to scale in the figures. It should be appreciated that like reference numerals are used to identify like elements illustrated in one or more of the figures.

### DETAILED DESCRIPTION

The present disclosure includes improved systems and methods for signal switching and/or filtering in radio frequency (RF) front end circuitry, in accordance with various embodiments. The present disclosure encompasses circuits, systems, and methods that enable stable and reliable SRS switching between antennas, in a system that may further include switching between TDD and FDD signal paths. Embodiments described herein may be implemented in 5G and 4G LTE cellular telephone systems as well as other types of wireless RF systems to mitigate EVM degradation, throughput degradation, and other performance degradation during antenna switching.

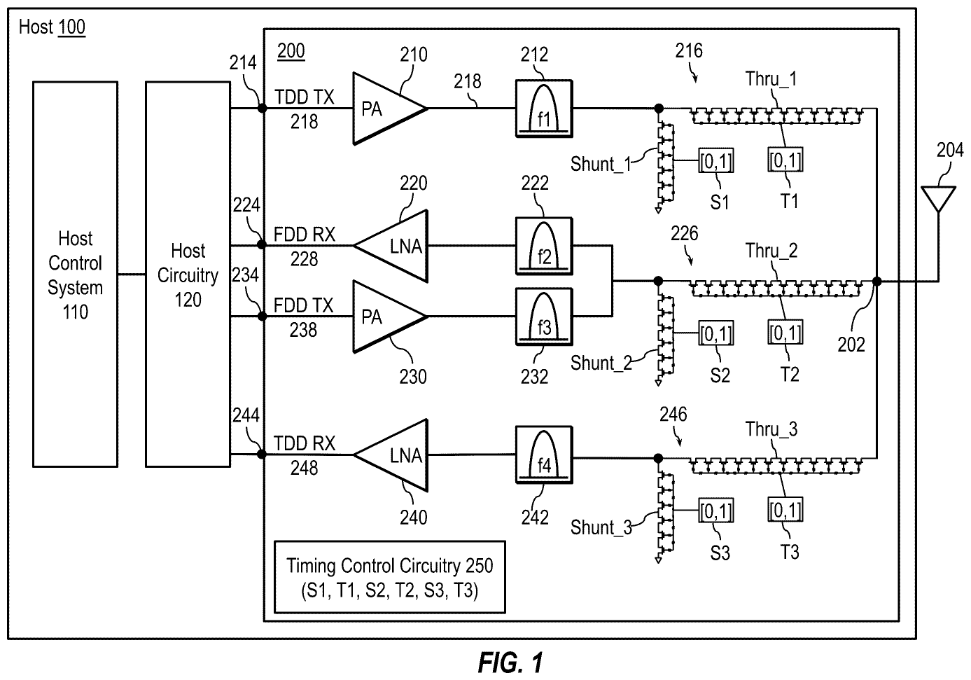

FIG. 1 illustrates an example host system 100 including a radio-frequency front end circuit 200, in accordance with embodiments of the present disclosure. As illustrated, the circuit 200 is configured to support both Time Division Duplex (TDD) and Frequency Division Duplex (FDD) communications. The circuit 200 includes an antenna port 202, which is connected to an antenna 204 for transmitting and receiving RF signals. The circuit 200 also includes a TDD input terminal 214, an FDD output terminal 224, an FDD input terminal 234, and a TDD output terminal 244, which are communicably coupled to the host 100, such as through host circuitry 120 and host control system 110. Switching circuitry (e.g., including switches 216, 226, 246) is configured to selectively couple the antenna port 202 to one or more RF signal paths.

The TDD input terminal 214 is configured to receive TDD signals from the host circuitry 120 for transmission through the antenna 204 via a TDD transmission path, TDD TX 218. The TDD TX 218 path includes a power amplifier 210 configured to amplify the received TDD transmit signal, a band pass filter 212 configured to output the signal in a TDD transmission frequency band, f1. The TDD transmit frequency band f1 may be any frequency band suitable for transmission of the TDD transmit signal, for example, Band 41 (2496 MHz-2690 MHz) according to the LTE (Long Term Evolution) standard. A switch 216 is configured to connect/disconnect the TDD TX 218 path to/from the antenna port 202.

The TDD output terminal 244 is configured to pass TDD signals received from the antenna 204 via antenna port 202 to the host 100, such as through the host circuitry 120 for processing by host control system 110. The TDD receive path, TDD RX 248, includes a switch 246, configured to connect/disconnect the TDD receive path to/from the antenna port 202 for receiving TDD signals from the antenna 204. The signal is passed through a band pass filter 242 which outputs the signal in a TDD receive frequency band, f4, which may be the same or similar to TDD transmit frequency band f1. The filtered signal is then passed through the low noise amplifier 240 for output to the host circuitry 120 through the TDD output terminal 244.

In various embodiments, the switches 216 and 246 may be configured to alternate between a TDD transmission mode and a TDD reception mode, in accordance with TDD signal timing. In some embodiments, the switches 216 and 246 may be implemented through a single switch that alternates communications between the two paths, or via other switch components.

The FDD output terminal 224 is configured to receive FDD signals from the antenna 204 via antenna port 202 for transmission to the host circuitry 120. The FDD receive path, FDD RX 228, includes a bandpass filter 222 configured to receive the FDD signal from the antenna 204, via the antenna port 202 and switch 226, and output a filtered signal in an FDD reception band, f2. The filtered signal is then passed through a low noise amplifier 220 for output to the host circuitry 120 through the FDD output terminal 224.

The FDD input terminal 234 is communicably coupled to the host circuitry 120 for receiving FDD output signals for transmission though the antenna 204 via switch 226 and antenna port 202. The FDD transmission path, FDD TX 238, includes a power amplifier 230 configured to boost the power of the FDD output signal and a band pass filter 232 configured to limit the FDD output signal to an FDD transmission frequency, f3. The switch 226 is configured to connect/disconnect the FDD transmission path FDD TX 238 and the FDD reception path FDD RX 228 to/from the antenna port 202. The FDD communication bands f2 and f3 may be, for example, Band 3 (transmit band: 1710 MHz-1785 MHz, receive band: 1805 MHz-1880 MHz) of the LTE standard, Band 25 (transmit band: 1850 MHz-1915 MHz, receive band: 1930 MHz-1995 MHz) of the LTE standard, supplemental uplink (SUL) or supplemental downlink (SDL) FDD bands, or other suitable frequency bands.

In operation, the FDD output terminal 224 and the TDD output terminal 244 are configured to transmit radio frequency signals received from the antenna 204 to the circuitry of the host apparatus, such as the host circuitry 120. The FDD input terminal 234 and the TDD input terminal 214 are configured to transmit radio frequency signals received from the host 100, such as through the host circuitry 120, to the antenna 204 for transmission to another device. The switches 216, 226, and 246 allow the antenna 204 to be selectively connected to one or more of the signal paths TDD TX 218, FDD RX 228/FDD TX 238, and TDD RX 248, depending on the type(s) of signals used for communication. In some embodiments, the switches 216, 226, and 246 are configured to facilitate simultaneous TDD/FDD communications, which may include connecting the switch 226 to the antenna port 202 for FDD simultaneous transmission and reception of FDD signals and controlling switches 216 and 246 to alternate between connecting the TDD transmission path, TDD TX 218, and the TDD receive path, TDD RX 248, in accordance with TDD signal timing, resulting in simultaneous TDD/FDD communications.

As illustrated, the circuit 200 may be implemented as an RF front end circuit that enables a host 100 to communicate via wireless communications. The host 100 may be any device and/or system capable of wireless communications, such as a mobile phone, smartwatch, a wireless wearable device, a manned or unmanned vehicle, of other wireless device and/or system. The circuit 200 may operate in TDD modes, FDD modes, and/or carrier aggregation modes. In an implementation of carrier aggregation including simultaneous communication using TDD signals and FDD signals, the switch 226 may be configured to maintain a continuous connection with the FDD communication paths FDD RX 228 and FDD TX 238, and the switches 216 and 246 may be configured to alternately connect to the TDD TX 218 and TDD RX 248 paths. The circuit 200 facilitates simultaneous use of TDD and FDD signal modes as described herein, enabling effective carrier aggregation for concurrent TDD and FDD signal communication. In various implementations, the switches 216, 226, and/or 246 may connect to one or more of the TDD and FDD signal paths and disconnect from unused paths.

In various embodiments, the host control system 110 may include one or more logic devices and memory devices configured to perform operations of the host 100. A logic device may be implemented as a general-purpose processor, a digital signal processor (DSP), an application-specific integrated circuit (ASIC), a microcontroller, a programmable logic device (PLD), a field-programmable gate array (FPGA), or other programmable logic device(s). The logic device and other components may be configured through hardwiring, software execution, or a combination of both. In various embodiments, the host control system 110 includes one or more memory devices designed to retain data, such as software instructions for execution by the logic device. The memory may include volatile and non-volatile memories, such as random-access memory (RAM), dynamic RAM (DRAM), static RAM (SRAM), non-volatile random-access memory (NVRAM), read-only memory (ROM), programmable read-only memory (PROM), erasable programmable read-only memory (EPROM), electrically-erasable programmable read-only memory (EEPROM), flash memory, hard disk drives, or other memory types. The logic device may be configured to execute software instructions residing in the memory, thereby accomplishing method steps and operations.

It will be appreciated that the circuit 200 of FIG. 1 is described at a high-level and that various other components may be included in an implementation. For example, the circuit 200 may include one or more phase adjusting circuits such as described in U.S. Pat. No. 11,677,427, which is incorporated by reference herein in its entirety. Various implementations may further include different numbers of communications paths, antennas, switches, and/or other components.

It has been observed that various implementations of RF front end circuitry that combines FDD and TDD signal paths simultaneously on the same antenna port, such as illustrated in FIG. 1, may generate signal errors during switching operations. In some cases, for example, TDD switching between TDD TX and TDD RX can result in a “glitch” in the FDD signal due to an impedance change at an FDD frequency (e.g., causing an Error Vector Magnitude (EVM) spike). One approach to resolve the glitch is to provide a common TDD TX/RX filter between the switch and the antenna port. This approach mitigates the glitch, but it constrains the filter options. For example, the TX filter may be selected with a larger filter loss to achieve higher out-of-band attenuation required for the transmission signal, while the RX filter may be selected with a lower power handling capacity, which may not be suitable for optimizing TX performance.

Switching at the antenna port (e.g., antenna port 202 as illustrated in FIG. 1) allows for optimal filter selection for each of the TDD TX and TDD RX paths (e.g., filters may be selected for target noise constraints, reliability in transmit SAW, insertion loss, etc.), and improved performance, but it adds to the complexity. Thus, a challenge addressed by the present disclosure is to operate with separate TDD TX and RX filters without performance degradation.

In various embodiments described herein, efficient implementations with separate TDD TX and RX filters, such as illustrated in FIG. 1, are disclosed with a TDD TX/RX switchover that is carefully designed to avoid sudden impedance changes (and associated gain/phase changes) presented to the FDD path. As illustrated, each switch of the switching circuitry (switch 216, switch 226, and switch 246) includes a thru switch and a shunt switch, which are operable to selectively couple the corresponding signal path to the antenna 204 via antenna port 202. TDD TX switch 216 includes a thru switch, Thru_1, and a shunt switch, Shunt_1, which include a plurality of transistors, selected in accordance with circuit requirements for the implementation.

In some implementations, the size of the Thru_1 switch and the Shunt_1 switch may be different (e.g., include different numbers and sizes of transistors), with the Thru_1 switch being larger than the Shunt_1 switch. The Shunt_1 switch is enabled/disabled by a control signal S1 (e.g., providing high or low signal value, 0=Off/1=ON, etc.), and the Thru_1 switch is enabled by a control signal T1. TDD RX switch 246 may be similarly configured with a thru switch Thru_3 controlled by a thru control signal T3, and a shunt switch Shunt_3 controlled by a shunt control signal S3. FDD switch 226 may be similarly configured with a thru switch Thru_2 controlled by a thru control signal T2, and a shunt switch Shunt_2, enabled/disabled by a shunt control signal S2.

In operation each of the thru switches (Thru_1, Thru_2, and Thru_3) are disposed between the corresponding signal path and the antenna port 202 to selectively couple the corresponding signal path to the antenna port 202 when enabled (e.g., when a “1” or high control input is provided). Each of the shunt switches (Shunt_1, Shunt_2, and Shunt_3) is connected between its corresponding signal path and RF ground. When enabled, each shunt switch is configured to isolate the corresponding signal path when the corresponding thru switch is disabled.

Switching operations may be controlled by timing control circuitry 250, which is configured to activate the shunt switch and disable a thru switch on a disabled signal path and disable the shunt switch and activate the thru switch on an enabled signal path. In some embodiments, the timing control circuitry 250 may be configured to control TDD switching between the TDD TX 218 path to transmit a TDD signal through the antenna 204, and the TDD RX 248 signal path to receive a TDD signal via the antenna 204. In some embodiments, the timing control circuitry 250 may be configured to mitigate TDD switching interfering with FDD signals in a carrier aggregation mode. The timing control circuitry 250 may be configured and/or scaled to adapt to different RF front end scenarios, including varying transistor sizes (e.g., of the switches 216, 226, and/or 246), filter properties, and process dimensions.

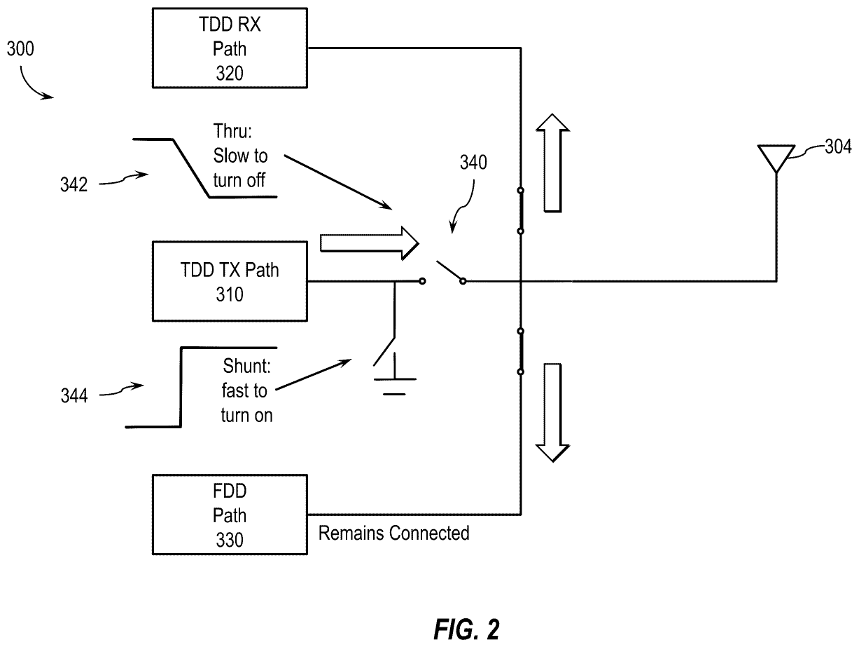

Referring to FIG. 2, switching operations of an RF front end circuit 300 will now be described, in accordance with embodiments of the present disclosure. The circuit 300 is configured to implement TDD-FDD carrier aggregation and includes a TDD TX path 310, a TDD RX path 320, and a full-duplex FDD path 33. Each transmission path is selectively connected to an antenna 304 via a switch, such as switch 340, which includes a thru switch connecting the transmission path to the antenna 304, and a shunt switch which is enabled when the corresponding transmission path is disconnected from the antenna 304. In operation, the FDD path 330 remains connected to the antenna during operation, and the TDD TX path 310 and TDD RX path 320 are alternately connected/disconnected to facilitate TDD communications.

In operation, the thru switch and shunt switch are enabled/disabled at different speeds. For example, the thru switch and shunt switch may include different numbers of transistors such that the thru switch, which is larger, is relatively slow to turn off (e.g., as illustrated by signal 342), and the shunt switch, which is smaller, is relatively fast to turn on (e.g., as illustrated by signal 344). In various implementations, design considerations may result in the thru switch being much bigger and/or containing more components than the shunt switch. As a result, when switching between the TDD TX path 310 and the TDD RX path 320, the shunt switches of the paths may be enabled/disabled before the thru switches are disabled/enabled.

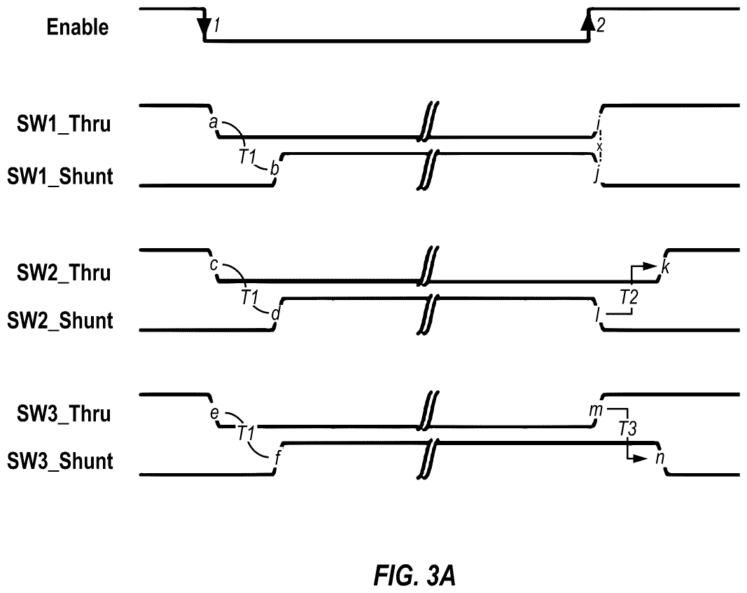

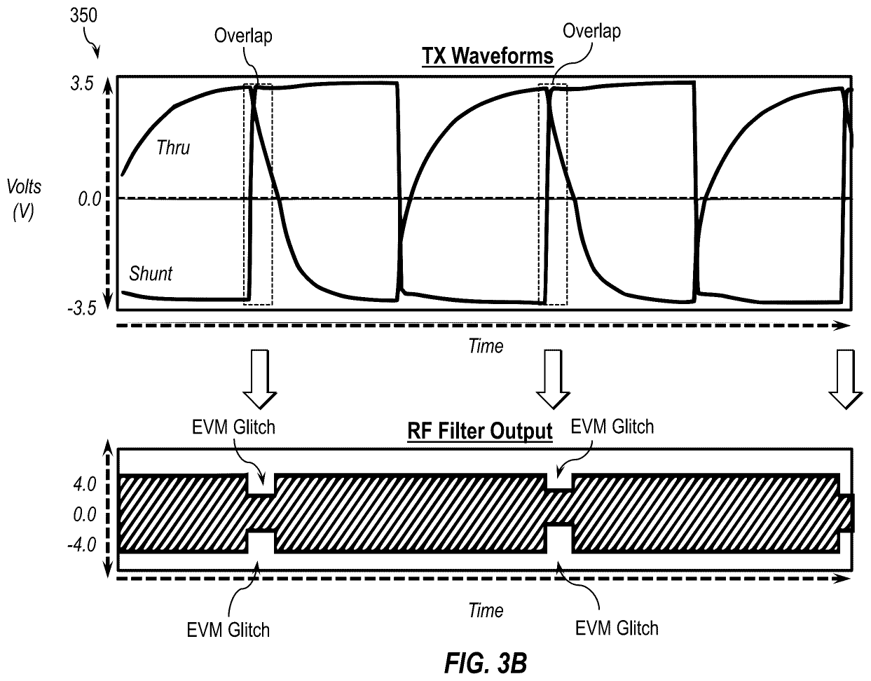

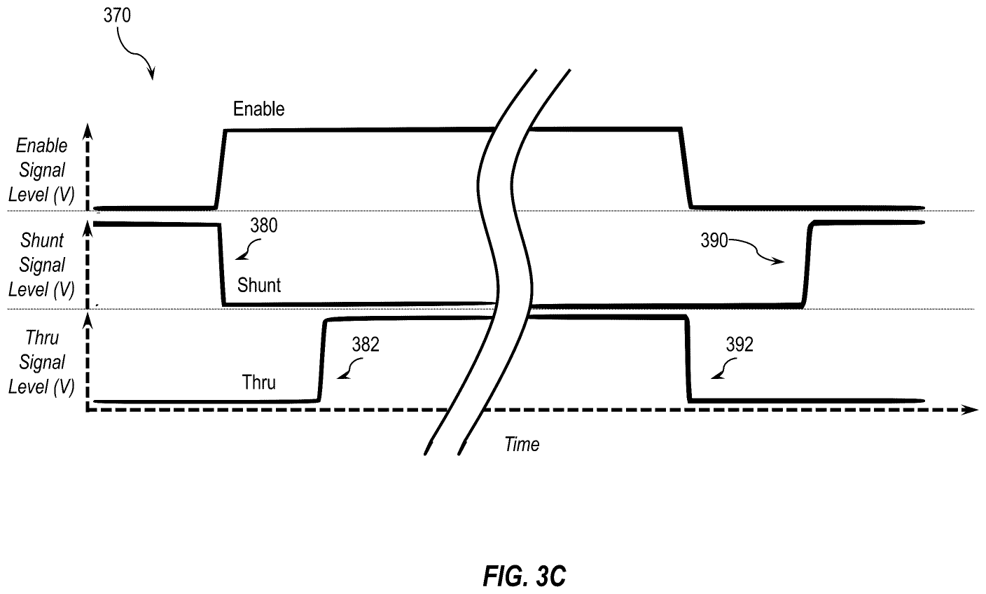

FIG. 3A illustrates a timing diagram illustrating various switching scenarios, in accordance with embodiments of the present disclosure. When the switch Enable signal goes low (e.g., at 1), the TDD switch is disabled (e.g., the thru switch is disabled, and the shunt switch is enabled). When the switch Enable signal goes high (e.g., at 2), a TDD switch is enabled (e.g., the thru switch is enabled, and the shunt switch is disabled). In a first scenario (SW1), a timing delay may be added, as shown by T1, to delay enabling the shunt path to account for the difference in the speed of the thru and shunt switches in disabling the TDD filter path and prevent inadvertent shunting due to the switching timing issue. In a second scenario (SW2), a second timing delay is added, as shown by T2, when the TDD filter path is enabled causing the Thru path to enable after the Shunt is disabled. In a third scenario, a third timing delay is added, as shown by T3, when the TDD path is enabled causing the Thru path to enable before the Shunt is disabled While the first scenario addresses the initial transition disabling a TDD signal path, the second and third scenarios address enabling the TDD path for different switch sequences to mitigate the EVM glitch.

Referring to FIG. 3B, example thru switch and shunt switch timing 350 are illustrated, in accordance with embodiments of the present disclosure. In the illustrated signal diagram, the shunt switch goes high at a faster rate than the thru switch turns off, creating an “Overlap” that causes corresponding “EVM glitches” at the filter output. These EVM glitches illustrate where the Overlap causes signal quality issues that are addressed by the present disclosure. In various embodiments, circuitry and/or control logic is provided to break (disabled) the shunt before the thru connection is made (enabled). As illustrated in FIG. 3A, these timing issues can occur at the when the filter path is disabled (e.g., as illustrated by delay T1) and/or when the filter path is enabled (e.g., as illustrated by delay T2/T3).

In various embodiments, it is desirable to maintain specific impedance characteristics within the output band of the band pass filters to mitigate the negative impact of switching between different frequency bands and modes on signal quality. For example, in some embodiments, the RF front end circuitry is designed to maintain approximately 50 ohms (or other value as appropriate for the specific implementation) across all filters. The EVM glitches caused by the switching may adversely affect signal quality, particularly in terms of interaction with other frequency bands. Two implementation considerations are the transition between states and the steady-state differences during operation.

The switching signal levels are further illustrated in the timing diagram 370 of FIG. 3C, in accordance with embodiments of the present disclosure. As illustrated, when the Enable signal goes high, the shunt switch is turned off at time 380. The thru switch is delayed until time 382 to avoid overlap with the shunt transition. This operation may be referred to as a shunt break, before a thru make. When the Enable signal goes low, the thru switch is turned off at time 392. The shunt switch is delayed until time 390 to avoid overlap with the thru transition.

For some cases of relatively smaller propagation delay on the shunt gate, it may not be necessary to delay the falling edge of the shunt signal because the gate turns off fast enough to avoid the EVM glitch issue. In some embodiments, the EVM glitch issue may be caused by the shunt rising edge, which was rising too fast. In various other implementations, the EVM glitch issue may be present at the rising and/or falling edges and mitigated as described herein. It will be appreciated that the EVM glitch issues discussed herein may affect either one or both of the FDD RX and FDD TX paths. To simplify the discussion, the present disclosure focuses on FDD RX glitches, which are generally more susceptible to EVM glitches.

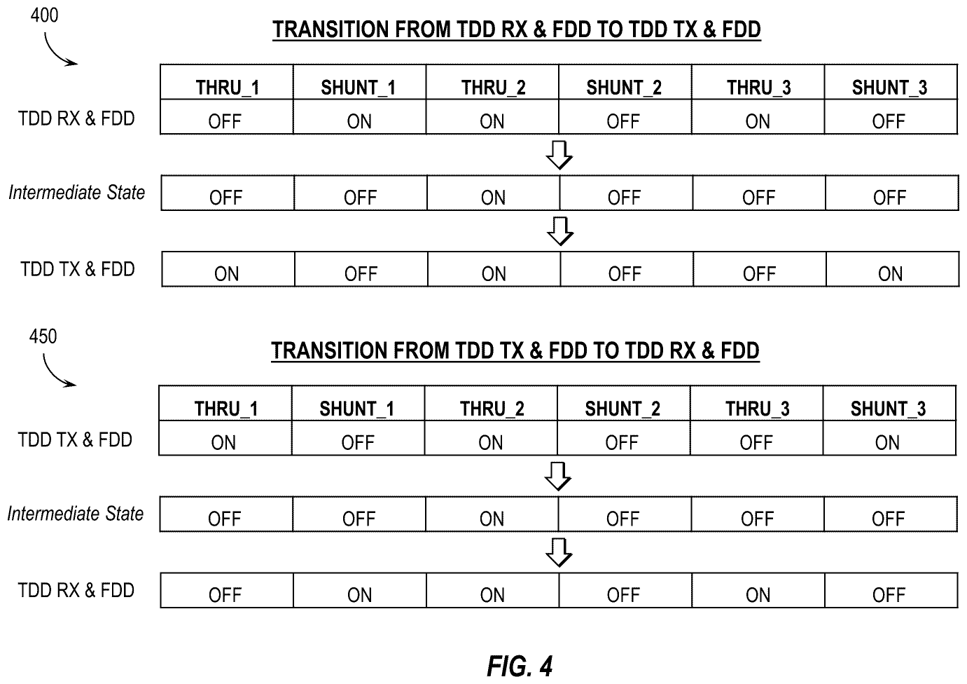

Referring to FIGS. 1 and 4, example switch timing sequences will now be described, in accordance with embodiments of the present disclosure. In the illustrated embodiment, a switch sequence 400 illustrates a transition from TDD RX to TDD TX, with the FDD paths continuously connected in a TDD-FDD carrier aggregation scenario. In the initial state, the TDD RX path 248 is connected to the antenna port 202 via switch 246 (Thru_3=1; Shunt_3=0), the FDD signal paths 228/238 are connected to the antenna port 202 via switch 226 (Thru_2=1; Shunt_2=0)), and the TDD TX path 218 is disconnected from the antenna port at switch 216 (Shunt_1=1; Thru_1=0). To switch from the TDD RX path 248 to the TDD TX path 218, an intermediate state is entered in which switch 246 and switch 216 are shut off (e.g., Shunt_1=0 and Thru_3=0). Next, the TDD TX path 218 is connected to the antenna port 202 via switch 216 (e.g., Thru_1=1) and the TDD RX path 248 is shunted (e.g., Shunt_3=1).

In the illustrated embodiment, a switch sequence 450 illustrates a transition from TDD TX to TDD RX, with the FDD paths continuously connected in a TDD-FDD carrier aggregation scenario. In the initial state, the TDD TX path 218 is connected to the antenna port 202 via switch 216 (Thru_1=1; Shunt_1=0), the FDD signal paths 228/238 are connected to the antenna port 202 via switch 226 (Thru_2=1; Shunt_2=0)), and the TDD RX path 248 is disconnected from the antenna port at switch 216 (Shunt_3=1; Thru_3=0). To switch from the TDD TX path 218 to the TDD RX path 248, an intermediate state is entered in which switch 216 and switch 246 are shut off (e.g., Shunt_3=0 and Thru_1=0). Next, the TDD RX path 248 is connected to the antenna port 202 via switch 246 (e.g., Thru_3=1) and the TDD TX path 218 is shunted (e.g., Shunt_1=1).

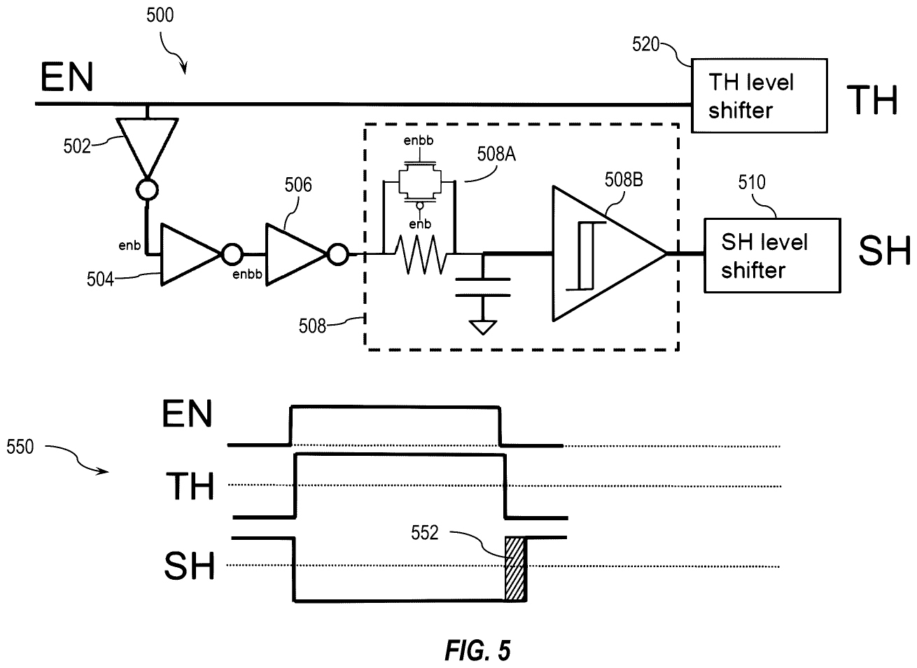

Referring to FIG. 5, embodiments of circuitry 500 for mitigating EVM glitches will now be described, in accordance with embodiments of the present disclosure. In some embodiments, the circuitry 500 may be implemented in accordance with the embodiments illustrated in FIGS. 1-4 to add timing delays to mitigate EVM glitches. In various embodiments, the EVM glitches may appear as a result of shunt/thru switch timing overlap and can be addressed by incorporating delay elements into the enable signal path. In the illustrated embodiment, only the rising shunt delay is needed because of the time constants of the example implementation. Other delay configurations may be implemented as desirable to avoid overlap in other circuit implementations (e.g., when delay is needed for the falling shunt control signal). This circuitry 500 is edge/direction selective depending on which edges are rising or falling.

As illustrated, a plurality of delay elements 502, 504, and 506 (e.g., inverters or other circuit components) are disposed in the shunt enable path. The shunt enable path may also include a level sensitive delay cell 508 (e.g., including a Schmitt trigger delay circuit 508B). In some embodiments, the delay cell 508 may be programmable (e.g., two values). The series resistor 508A may be either shorted out or not shorted out, and the Schmitt trigger 508B functions to mitigate bounces.

The added delay (illustrated, for example, as delay 552 in signal diagram 550) creates time for the thru gate signal to settle to “off” before the shunt switch device is switched on. Depending on the TX and RX surface acoustic wave (SAW) impedance presented to the FDD path and system tolerance to FDD gain/phase jumps, it may be desirable to control TX and RX overlap/nonoverlap. For example, if TX and RX are both “off” momentarily, FDD impedance could spike during that time. A TH level shifter 520 and SH level shifter 510 are provided at the outputs of the circuitry 500 to generate the switching control signals for each of the thru switch and shunt switch.

The circuit 500 of FIG. 5 illustrates one approach for mitigating and/or avoiding impedance changes in RF front end circuitry for use with FDD-TDD carrier aggregation. The use of delay cells disposed in the circuit 500 to ensure a shunt/break occurs before a thru/make allows for programmability and mitigates undesirable values of a gate resistor (e.g., a very large gate resistor). The circuit 500 mitigates issues with the FDD filter being exposed to an impedance glitch if thru-shunt (and TX-RX) timing is not carefully controlled.

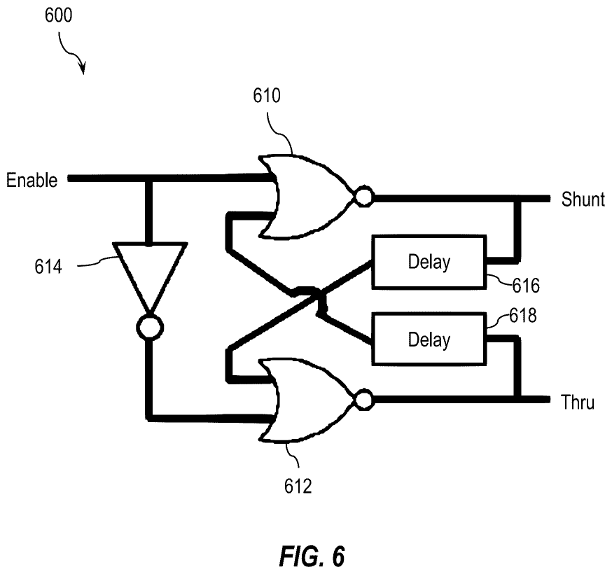

Referring to FIG. 6, another embodiment of a circuit for mitigating EVM glitches will now be described, in accordance with embodiment of the present disclosure. The circuit of FIG. 6 may be used in place the circuit 500 of FIG. 6 in some implementations. As illustrated, the circuit is implemented as a non-overlap generator circuit 600 configured to implement a time delay between the switched signals and includes NOR gates 610 and 612, an inverter 614, and delay elements 616 and 618. Implementation of the non-overlap generator 600 can help avoid the scenario where the TDD transmit filter and TDD receive filter are simultaneously active. It will be appreciated that other non-overlap generator configurations may be implemented in accordance with the present disclosure (e.g., a level shifting function may be incorporated into the design).

In operation, an Enable input signal controls the operation of the non-overlap generator 600. When Enable goes high, the shunt signal goes low. The Thru signal remains low until the signal propagates through the delay element 616 to the bottom NOR 612 and then out. When enabled, the non-overlap generator 600 introduces timing delays through the delay elements 616 and 618, which triggers the shunt control before the thru control, creating a time gap to avoid overlap during switching. When disabled, the signals can bypass the delay elements. In various embodiments, the delay cells 616 and 618 may be implemented using a set/reset latch circuitry or other appropriate delay components. Although a NOR implementation is illustrated, it will be appreciated that NAND implementations or other implementations may also be used. The delays in this circuitry can be programmed and scaled, making it adaptable to different scenarios, including varying transistor sizes and process dimensions.

The circuits of FIGS. 5 and 6 address challenges related to separating transmit (TX) and receive (RX) paths using separate filters, such as separate TDD paths in a TDD-FDD carrier aggregation implementation. By separating the TX and RX paths, the RF front end can be implemented with improved noise and reliability, compared with a single path approach. In operation, the FDD downlink path is constantly present, which presents switching challenges. As previously discussed, the relatively small shunt switch's rapid transition creates overlap with the slower thru switch, causing an EVM glitch in the FDD filtered signal. The circuits of FIGS. 5 and 6 allows for precise switching/timing to mitigate these EVM glitches.

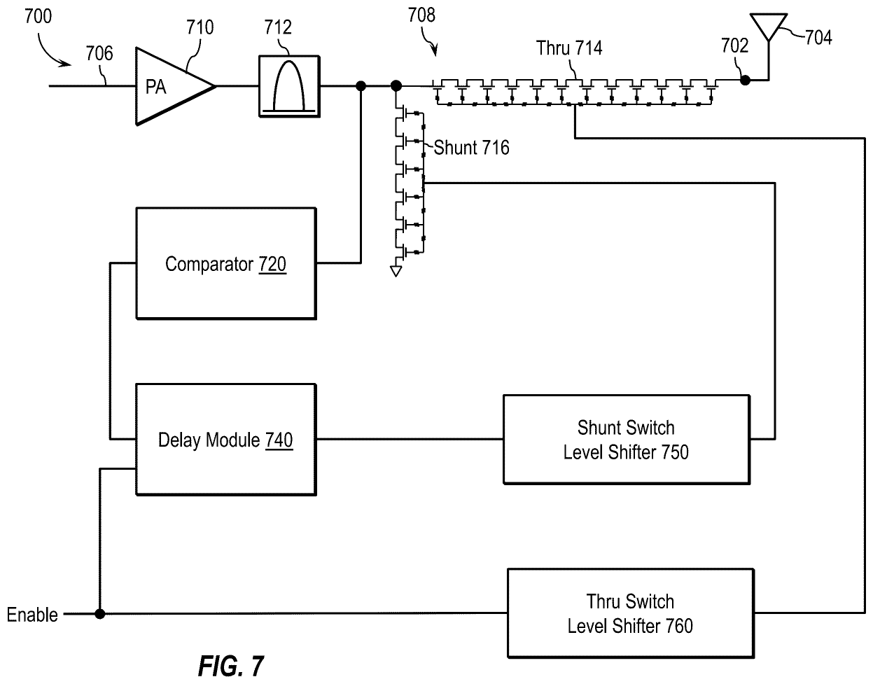

FIG. 7 illustrates an implementation of front end circuitry 700 that includes the shunt switch/thru switch control timing as described herein, in accordance with embodiments of the disclosure. The circuitry 700 may be implemented in an RF front end circuit, such as circuit 200 of FIG. 1. The circuitry 700 includes a radio-frequency transmission path 706, which may be implemented as a TDD TX path, such as TDD TX path 218 illustrated in FIG. 1. The switching elements of circuitry 700, including switch 708 which includes thru switch 714 and shunt switch 716 which are enabled by an Enable signal, comparator 720, delay module 740, shunt switch level shifter 750 and/or thru switch level shifter 760, may be implemented in one or more other transmission and reception paths of the RF front end circuitry, such as TDD RX path 248 of FIG. 1.

The transmission path 706 receives an RF signal for transmission through antenna 704, such as from a host system. The received signal is amplifier by power amplifier 710 and passes through a band pass filter 712 to generate a signal in the TDD transmission frequency band. The signal passed through the Thru switch 714 which, when enabled, connects the transmission path 706 to the antenna 704 via antenna port 702. The comparator 720 and delay module 740 include circuitry configured to control the timing of the enable signa to the Thru switch 714 and Shunt switch 716, such as disclosed herein in FIGS. 1-6 to mitigate EVM glitches. In some embodiments, the comparator 720 and delay module 740 may be implemented as circuitry such as illustrated in the circuit 500 of FIG. 5 which includes, respectively, a level sensitive delay cell 508 and a plurality of delay elements 502, 504, and 506. In some embodiments, the circuitry 700 is implemented with the overlap circuit 600 of FIG. 6.

The RF front end circuitry 700 may be implemented in circuitry of a host system comprising multiple RF signal paths and timing control circuitry, such as described with reference to FIG. 1. Switching circuitry is configured to selectively couple the plurality of RF signal paths to an antenna port, the switching circuitry including, for each of the plurality of RF signal paths, a thru switch that connects a corresponding RF signal path to the antenna port when activated, and a shunt switch connected between its corresponding signal path and RF ground. The shunt switch isolates the corresponding RF signal path when the thru switch is deactivated. Additionally, the timing control circuitry is configured to activate the shunt switch on a disabled RF signal path and the thru switch on an enabled RF signal path in a sequential manner.

In some configurations, the RF signal paths include a time-division duplexing (TDD) transmit signal path and a TDD receive signal path, and the switches are set up to alternate between these paths, allowing transmission and reception of TDD signals. The RF signal paths may also include a frequency division duplexing (FDD) signal path, facilitating the transmission and reception of FDD signals. This configuration serves as an RF front end circuit that facilitates carrier aggregation.

The timing control circuitry for each TDD path includes a thru control signal path connecting a control signal to the thru switch and a shunt control signal path with at least one delay element to delay the shunt control signal. The latter may include a resistor-capacitor circuit receiving the delayed shunt control signal and a Schmitt trigger to condition the delayed control signal for output to the shunt switch. In some embodiments, the timing control circuitry may include a non-overlap circuit for each TDD path configured to respond to the control signal, activating one of the TDD transmit or receive paths while deactivating the other, ensuring no overlap in their operations.

FIG. 8 illustrates an example switching process 800 for switching between a TDD RX mode to a TDD TX mode, in accordance with one or more embodiments. In operation 802, RF front end circuitry (e.g., circuitry described with reference to FIGS. 1-7) is configured for FDD/TDD carrier aggregation, including continuous FDD TX/RX paths. In operation 804, the circuitry operates in a TDD RX mode, including setting a TDD RX thru switch to ON, a TDD RX shunt switch to OFF, a TDD TX thru switch to OFF, and a TDD TX shunt switch to ON. The FDD TX/RX path is also switched on for continuous processing, including setting an FDD thru switch to ON and a FDD shunt switch to OFF. In this configuration, the circuitry receives TDD RX signals (operation 806).

In operation 808, the timing control circuitry begins transition to the TDD TX mode by setting the TDD TX shunt gate to OFF and the TDD RX thru gate to OFF. In operation 810, the timing control circuitry sets the TDD TX thru gate to ON and the TDD RX shunt gate to ON. In this configuration, the circuitry is capable of transmitting TDD TX signals (operation 812).

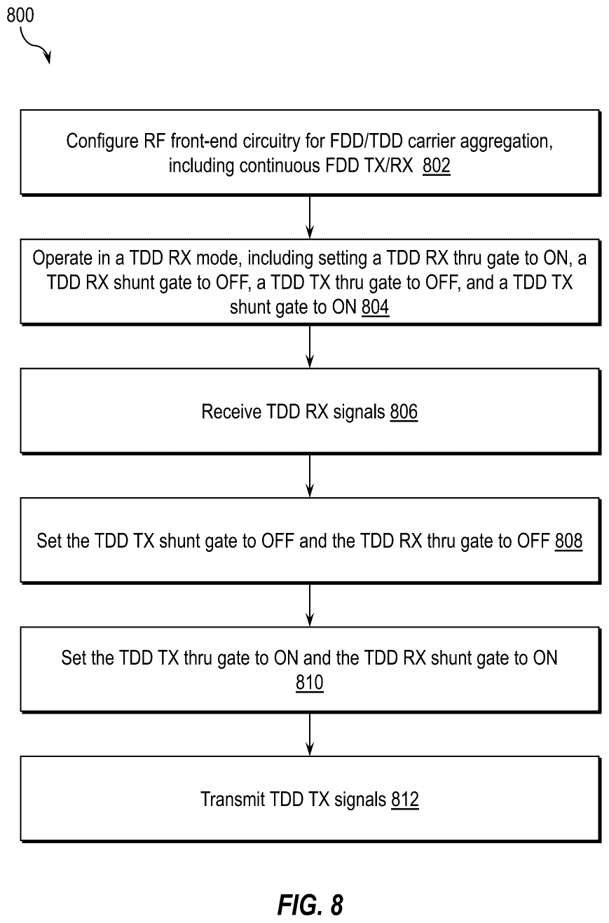

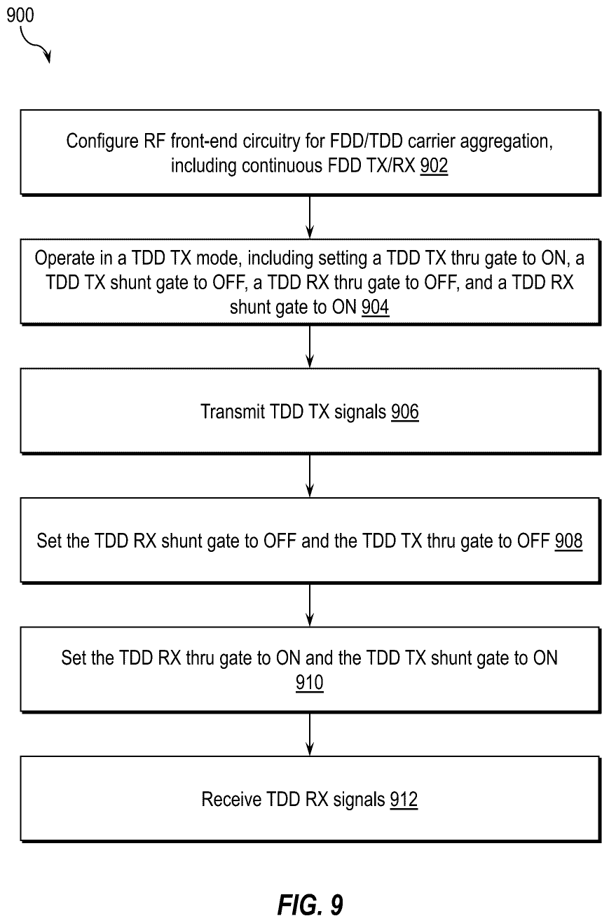

FIG. 9 illustrates an example switching process 900 for switching between a TDD TX mode to a TDD RX mode, in accordance with one or more embodiments. In operation 902, RF front end circuitry (e.g., circuitry described with reference to FIGS. 1-7) is configured for FDD/TDD carrier aggregation, including continuous FDD TX/RX paths. In operation 904, the circuitry operates in a TDD TX mode, including setting a TDD TX thru switch to ON, a TDD TX shunt switch to OFF, a TDD RX thru switch to OFF, and a TDD RX shunt switch to ON. The FDD TX/RX path remains switched on for continuous processing, including setting an FDD thru switch to ON and a FDD shunt switch to OFF. In this configuration, the circuitry is configured to transmit TDD TX signals (operation 906).

In operation 908, the timing control circuitry begins transition to the TDD RX mode by setting the TDD RX shunt gate to OFF and the TDD TX thru gate to OFF. In operation 910, the timing control circuitry sets the TDD RX thru gate to ON and the TDD TX shunt gate to ON. In this configuration, the circuitry receives TDD RX signals (operation 912).

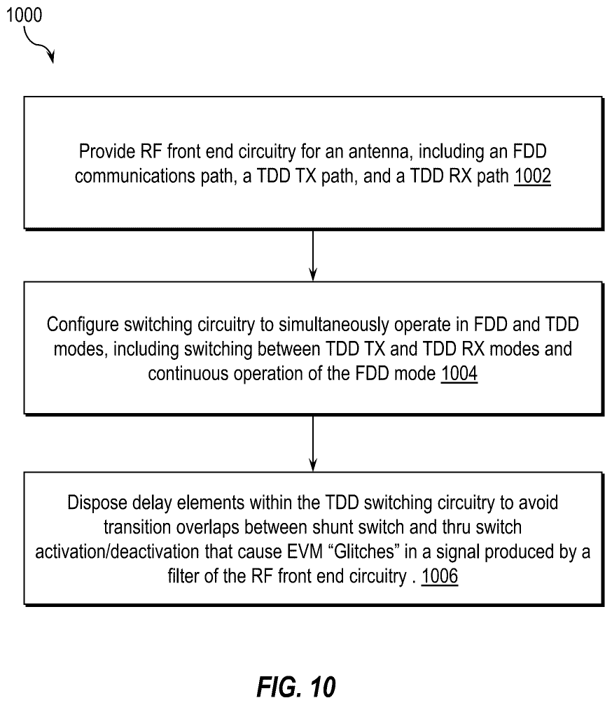

FIG. 10 illustrates an example process 1000 for configuring circuitry, for example as described herein with respect to FIGS. 1-9. In operation 1002, RF front end circuitry is provided for an antenna, including an FDD TX/RX communications path, a TDD TX path, and a TDD RX path switchably coupled to the antenna. Next, in operation 1004, the switching circuitry is configured to simultaneously operate in FDD and TDD modes, including switching between TDD TX and TDD RX modes and continuous operation of the FDD mode. In operation 1006, delay elements are disposed within the switching circuitry to avoid transition overlaps in shunt switch and thru switch activation/deactivation timing that cause EVM “Glitches” in a signal produced by a filter of the RF front end circuitry. Analysis and solutions to this problem are discussed with reference to FIGS. 2-7.

In various embodiments, communications systems and devices (e.g., host 100), may further include one or more reference signal paths (e.g., an SRS signal path) which are periodically coupled to the antenna(s) to facilitate transmission of one or more sounding reference signals to a base station of the communications system. In some embodiments, switching between an SRS signal path and one or more data signaling paths (e.g., TDD and FDD paths) in a multiple antenna system may be implemented in accordance with U.S. Patent Publication No. 2023/0091678, which is incorporated herein by reference in its entirety. In some embodiments, each antenna may include FDD/TDD switching as described herein, and SRS switching across a plurality of antennas as described in U.S. Patent Publication No. 2023/0091678.

It has been observed that switching the SRS signal path at the antenna switch may result in signal degradation in the FDD band. For example, a phase/gain discontinuity may occur in the FDD RX path during TDD SRS switching due to different path (e.g., filter) loading, which can cause error vector magnitude (EVM) degradation in the receive symbol and reduced data throughput. Minimizing EVM degradation in SRS switching is desirable for maintaining signal quality and reliability of wireless communications links.

Various solutions may include addressing phase/gain issues in the antenna switch, which can increase switch design complexity, and/or adding an additional SRS dedicated filter, which can increase cost. Another potential solution is to address compensation from the baseband modem, but this may be impractical in an implemented system when multiple vendors and communications standards are involved. Another potential solution is to use a separate antenna for TDD and FDD, but this would increase number of antennas in the user equipment.

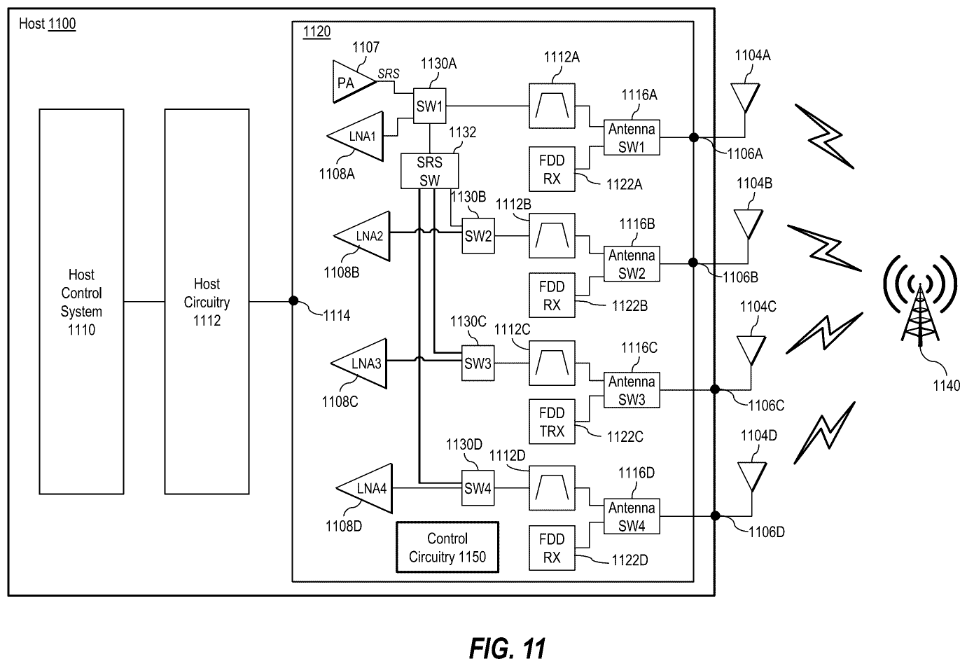

Various embodiments addressing signal degradation in SRS signaling are disclosed herein with reference to FIGS. 11-14, which include disposing SRS switching circuitry between the TDD filter of a TDD signal path and the amplifier of an SRS signal path. For example, SRS switching for a four antenna (4RX), or eight antenna (8RX) system may be performed before each TDD filter, which mitigates and/or eliminates the discontinuity issue for the FDD RX path and through-put degradation in the FDD RX path.

FIG. 11 illustrates an example radio-frequency (RF) front end 1120 in a single transmitter, four receiver configuration (1T4R) that mitigates signal degradation associated with SRS switching. As illustrated, SRS switching is performed after a power amplifier of the SRS signal path and before the TDD filter. In this configuration, the loading impact in the FDD RX path is mitigated/eliminated and the phase/gain discontinuity impacting the FDD RX path is mitigated. As illustrated, SRS transmitting passes through TDD filters in each TDD path and FDD RX through-put degradation is not expected. The embodiments disclosed herein can utilize FDD+TDD CA combinations in several bands and may include the TDD-FDD antenna switching disclosed herein with reference to FIGS. 1-10.

The RF front end 1120 is implemented on a host 1100 that may include a host control system 1110 and host circuitry 1112 coupled to the RF front end circuit 1120. Various components illustrated in FIG. 11, may be implemented using corresponding components as previously described with reference to FIGS. 1-10. For example, the host system 1100 may be implemented as a host 100, the host control system 1110 may be implemented as a host control system 110, and host circuitry 1112 may be implemented as host circuitry 120.

As illustrated, the RF front end circuit 1120 is configured to support both TDD and FDD communications. The circuit 1120 includes a plurality of antenna ports 1106A-d, which correspond to a plurality of antennas 1104A-D, respectively, for transmitting and receiving RF signals. The RF front end circuit 1120 also includes one or more input and output terminals 1114, which are communicably coupled to the host 1100, such as through host circuitry 1112 and host control system 1110. Switching circuits, including switching circuitry 1130A-D, 1132, and 1116A-D, are configured to selectively couple the antenna ports 1106A-D and antennas 1104A-D to one or more RF signal paths, which may include an SRS signal path and a plurality of FDD and TDD signal paths.

The RF front end circuit 1120 further includes control circuitry 1150 configurable to control the switching of circuit 1120, including SRS switching. As illustrated, the RF front end circuit 1120 further includes a plurality of amplifiers including an SRS amplifier 1107 configurable to generate the SRS transmit signal, low noise amplifiers (LNA1-4) 1108A-D and filters 1112A-D. As illustrated, each antenna 1104A-D is switchably couplable via its corresponding antenna switch 1116A-D and antenna port 1106A-D to a transmit path including filters 1112A-D, a receive path 1122A, 1122B, and 122D, and/or a transceiver path 1122C.

The plurality of switches 1130A-D and switch 1132 facilitate multi-way switching to couple the plurality of antennas 1104A-D to the SRS amplifier 1107, which may be implemented as a power amplifier (PA), and to corresponding low-noise amplifiers 1108A-1108D. In various embodiments, the switches 1130A-1130D are configured to facilitate electrical coupling of any amplifier (PA 1107 or LNA 1108A-D) to any antenna 1104A-D, thus allowing both transmission and reception of RF signals. In some embodiments, the multi-way switches may include circuitry that functions to separate transmitted and received signals, such as duplexers.

In some embodiments, the amplifiers and the switches may be fabricated on a single IC die. In other embodiments, the amplifiers and the switches may be fabricated on a two or more IC dies. For example, the amplifier 1107, LNAs 1108A-B, switches 1130A and 1130B, and all or a portion of switch 1132 may be fabricated on a first IC die, with the corresponding signal paths (filters 1112A-B, FDD RX circuitry 1122A-B, and antenna ports 1106A-B), while LNA 1108C-D, switches 1130C-D, and all or a portion of switch 1132 and may be fabricated on a second IC die, with the corresponding signal paths (filters 1112C-D, FDD TRX/RX circuitry 1122C-D, and antenna ports 1106C-D).

The RF front end circuit 1120 utilizes one or more reference signals to provide information about the quality of a signal channel to one or more base stations 1140. For example, in the 5G NR and 4G LTE cellular telephone systems, a Sounding Reference Signal (SRS) transmission may be used to facilitate resource allocation for downlink transmission, link adaptation, and to decode transmitted data from user equipment, such as host 1100. An SRS transmission may be periodically transmitted by the RF front end circuit 1120 of the host 1100, through the plurality of antennas 1104A-D to a network component, such as base station 1140, which may be implemented in accordance with a wireless communications protocol (e.g., a “gNB” in a 5G communication system). The SRS transmission may provide information, for example, about the combined effect of multipath fading, scattering, Doppler, power loss of the transmitted signal, and the like. Such information may be used by the base station 1140 or other network component, for example, using channel reciprocity to estimate the downlink channel quality in different sections of the channel bandwidth and enable uplink frequency selective scheduling to optimize link budget parameters and throughput. In various embodiments, the SRS transmission may include single SRS transmissions, periodic SRS transmissions, and/or aperiodic SRS transmissions. In some embodiments, reference signals as described herein may be transmitted to the based station 1140 in accordance with other protocols.

The switches 1130A-D and switch 1132 may be implemented using any appropriate switch. In various embodiments, one or more of the switches 1130A-D and switch 1132 may be implemented as one or more multi-way switches, including one or more switches configured for hot switching, as disclosed in U.S. Patent Publication No. 2023/0091678. For example, under current standards for 5G NR and 4G LTE cellular telephone systems, an SRS transmission may occur in certain locations of a resource slot (a slot being a sub-unit of a standard radio frame), with a time interval between signal transmissions due to antenna switching. The time interval per antenna transition allows for RF power to be turned OFF, switching to a next antenna for SRS symbol transmission, and then for RF power to be turned ON (e.g., “cold switching”).

Although a 1T4R configuration is illustrated in FIG. 11, various FDD/TDD carrier aggregation combinations are available for use in wireless devices, such as host 1100. Such combinations may include various combinations of antennas, transmit paths, and receive paths using SRS antenna switching. Different configurations may include, for example, 4 antenna configurations such as 1T4R (1 transmit, 4 receive) and 2T4R (2 transmit, 4 receive), and 8 antenna configurations such as 1T8R (1 transmit, 8 receive) and 2T8R (2 transmit, 8 receive). For example, the RF front end circuitry 1120 may be configured for SRS antenna switching in a 1T4R configuration in which SRS signals from a single PA are transmitted on 4 different antennas, with one antenna selected for transmission at a time.

In various embodiments, the switching circuits of RF front-end 1120 support “hot switching” as described in U.S. Patent Publication No. 2023/0091678. Such a circuit implements a definitive, well-controlled switch sequence that avoids excess voltage in the switch arms and harmonic generation while speeding up switching transitions. Thus, rather than have a relatively long (e.g., 15 μs) switching transient during which RF power to a switch is OFF, the RF power remains ON during switching. Elimination of the long switching transient enables elimination of the normally required time interval after each SRS transmission. With such time interval removed, in a 1T4R RF transceiver front end configuration, the SRS transmissions may be implemented using only 4 symbols that can be packed into a single slot. In some configurations, it may be desirable to use 4 slots to maximize symbol usage for communication.

It will be appreciated that FIG. 11 is a simplified diagram illustrating certain components and connections therebetween of the circuit 1120 and host system 1100 at a high level to provide an understanding of the present disclosure to one of ordinary skill in the art. It will be understood that other components, connections, and details will be present in an implemented embodiment. Further, while a 1T4R system is illustrated, it will be understood that the circuit 1120 may be implemented using various numbers of transmit paths, receive paths, and antennas, in accordance with embodiments of the present disclosure.

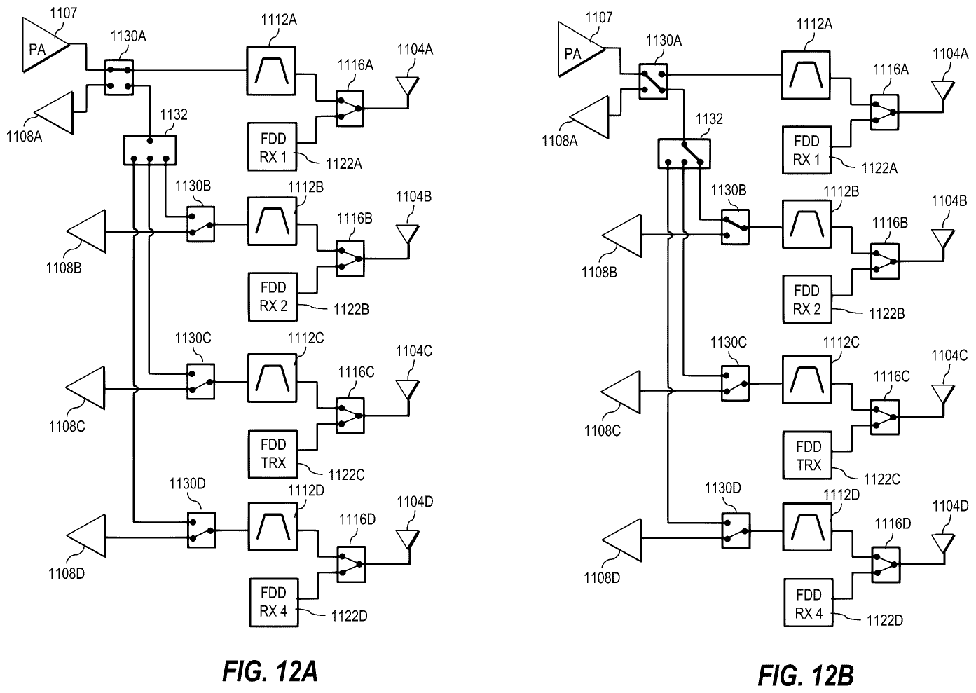

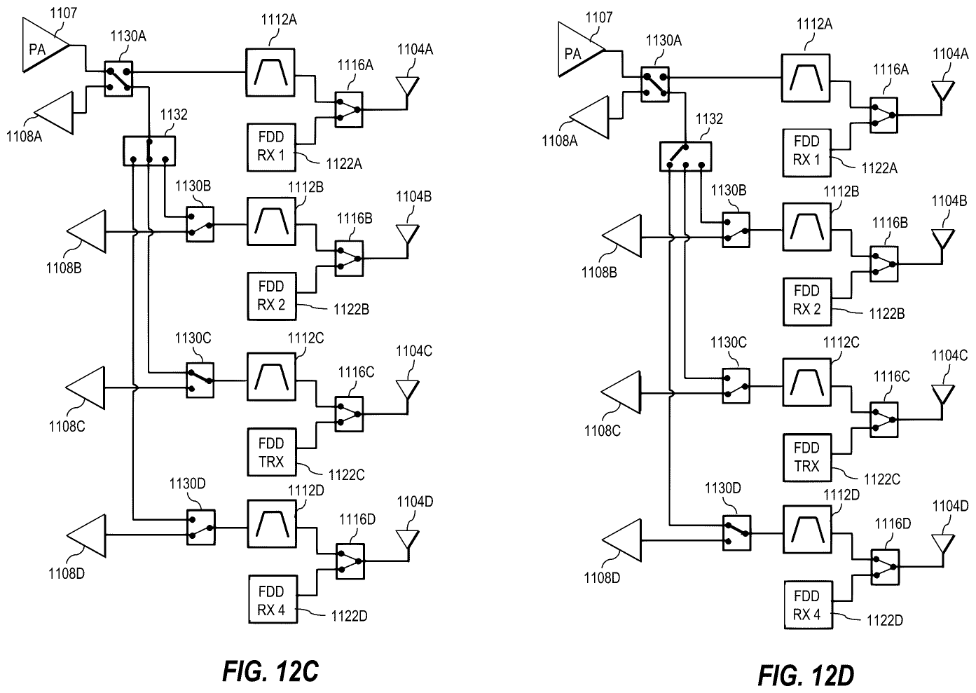

Operation of the RF front end circuit 1120 will now be described in further detail with reference to FIGS. 12A-D, which illustrate various SRS switching configurations in accordance with one or more embodiments of the present disclosure. In various communications systems, such as 5G, the switching circuitry is configured to transmit SRS signals from each antenna 1104A-D. The SRS switching may be controlled via control circuitry 1150 as in FIG. 11, which is configured to control operation of SRS switching in accordance with one or more wireless communications protocols. For example, in a 1T4R system with 4 antennas, when SRS switching is set to the first antenna (SRS 1) there is no EVM degradation since SRS is transmitting through a normal state to antenna 1104A. For other SRS switching scenarios, SRS 2 (FDD RX 1 and FDD RX 2), SRS 3 (FDD RX 1 and FDD RX 3) and SRS 4 (FDD RX 1 and FDD RX 4), EVM degradation and through-put degradation is expected. If the EVM degradation occurs in a control channel (e.g., a Physical Downlink Control Channel (PDCCH)), then it may prevent demodulation of the signal. This degradation may occur in various FDD-TDD carrier aggregation combinations, including 8RX MIMO configurations.

FIG. 12A illustrates a switching configuration setting the SRS port to the first antenna signal path (SRS 1). As illustrated, switch 1130A is configurable to couple amplifier 1107 to the first antenna 1104A. In some embodiments, the switches 1130A-D and switch 1132 are implemented for hot switching, including a port configured to pass an RF signal, a plurality of switch arms each coupled to the port and including an associated node, and a shunt termination impedance selectively electrically couplable to the port through a switch.

In some embodiments, the shunt termination impedance of the hot switch may be coupled by the switch to the port before a first switch arm transitions from an ON state to an OFF state while the remaining switch arms of the plurality of switch arms are in the OFF state, while the first switch arm transitions to the OFF state while the remaining switch arms of the plurality of switch arms are in the OFF state, and while a second switch arm of the plurality of switch arms transitions from the OFF state to the ON state while the first switch arm is in the OFF state. The shunt termination impedance, which may include a resistor, may be otherwise electrically disconnected from the port. The switch arm may include a serial switch coupled between the port and the associated node, and one or more switch arms may include a shunt switch coupled to the associated node and configured to be coupled to a reference potential.

It will be appreciated that embodiments of FIGS. 12A-D are illustrated at a high level to provide an understanding of the present disclosure to one of ordinary skill in the art. It will be understood that other components, connections, and details will be present in an implemented embodiment, including for example, embodiments of switches 1130A-D and 1132 which may be implemented as described in U.S. Patent Publication No. 2023/0091678, which is incorporated herein by reference, and embodiments of components and connections of the FDD signal path, TDD signal path, and/or antenna switching (e.g., filters 112A-D and switches 1116A-D), which may be implemented as described, for example, with reference to FIGS. 1-11 herein.

FIG. 12B illustrates a switching configuration setting the SRS port to the second antenna signal path (SRS 2). As illustrated, switch 1130A is configurable to couple amplifier 1107 to a second switch 1132, which is selectively couplable to the second antenna 1104B, third antenna 1104C, and fourth antenna 1104D. In the illustrated configuration, switch 1132 is configured to couple the SRS signal to switch 1130B which is configurable to couplable the received SRS signal to the second antenna 1104B. FIG. 12C illustrates a switching configuration setting the SRS port to the third antenna signal path (SRS 3). As illustrated, switch 1130A is configurable to couple amplifier 1107 to the second switch 1132, which is selectively coupled to the third antenna 1104C, via switch 1130C. FIG. 12D illustrates a switching configuration setting the SRS port to the fourth antenna signal path (SRS 4) As illustrated, switch 1130A is configurable to couple amplifier 1107 to the second switch 1132, which is selectively coupled to the fourth antenna 1104D, via switch 1130D.

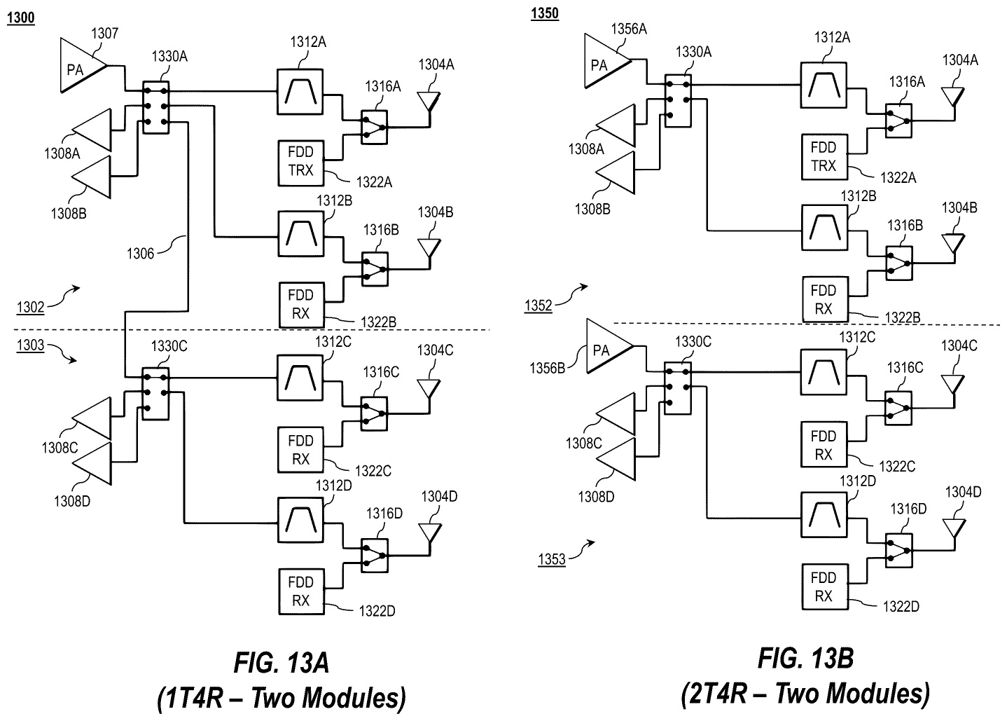

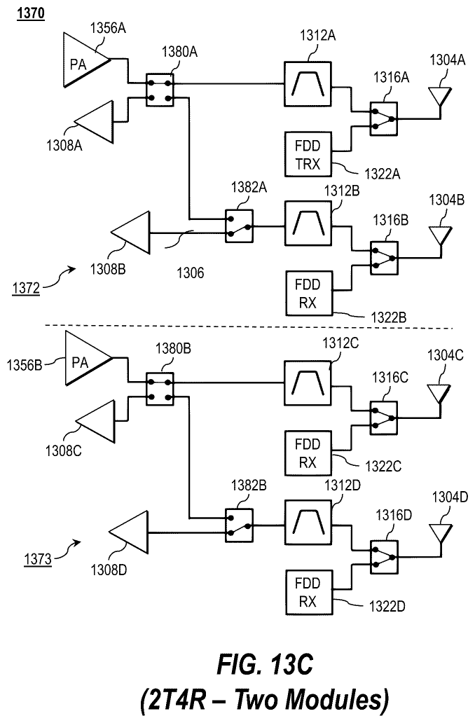

Referring to FIGS. 13A-C, additional SRS switching examples will now be described in accordance with one or more embodiments of the present disclosure. As previously discussed, providing SRS antenna switching before the TDD filter provides advantages by mitigating/eliminating the loading impact in the FDD RX path and the phase/gain discontinuity impacting the FDD RX path in conventional systems. Various configurations may include, but are not limited to 1T4R, 2T4R, 1T8R, 2T8R and 4T8R, which may be implemented using various discrete components and modules to configure the RF front end. The SRS switching may be controlled via control circuitry (e.g., control circuitry 1150 of FIG. 11) configured to control operation of SRS switching in accordance with one or more wireless communications protocols.

It will be appreciated that embodiments of FIGS. 13A-C are illustrated at a high level and to provide an understanding of the present disclosure to one of ordinary skill in the art. It will be understood that other components, connections, and details will be present in an implemented embodiment, including for example, embodiments of components described herein with reference to FIGS. 1-12D.

FIG. 13A illustrates 1T4R circuitry 1300 implemented in two modules, a first circuit module 1302 and a second circuit module 1303. The 1T4R circuitry 1300 includes 4 antennas 1304A-D, which are switchable couplable to TDD and FDD signal paths (1312A-D and 1322A-D) via switching circuitry 1316A-D, respectively. The modules 1302 and 1303 may be electrically coupled via one or more signal lines 1306. The two modules 1302 and 1303 may be implemented as two separate integrated circuits, each having its own control circuitry. In some embodiments, the control circuitry of the first module 1302 and control circuitry of the second module 1303 may be implemented in a master-slave relationship. In some embodiments, the switches of the two modules 1302 and 1304 may be controlled by common control circuitry.

As illustrated, switch 1330A is configurable to couple antenna 1304A to amplifier 1308A and antenna 1304B to amplifier 1308B. The switch 1330A is further configurable to provide SRS switching between the amplifier 1307, antenna 1304A, antenna 1304B, and switch 1330C of the second module 1303 (e.g., to use antenna 1304C or 1304D for SRS signaling). Switch 1330C is configurable to couple antenna 1304C to amplifier 1308C and antenna 1304D to amplifier 1308D. The switch 1330C is further configurable to provide SRS switching between the amplifier 1307 and antenna 1304C and antenna 1304D.

FIG. 13B illustrates 2T4R front end circuitry 1350 implemented in two modules, a first module 1352 and a second module 1353. The 2T4R circuitry 1350 includes 4 antennas 1304A-D, which are selectively couplable to the TDD and FDD signal paths (1312A-D and 1322A-D) via switching circuitry 1316A-D, respectively. In various embodiments, the modules 1352 and 1353 are configured with separate SRS switching control circuitry. The switches may include a first multi-way switch coupled to multiple antennas (two, in this example) to a first power amplifier 1356A, and to multiple low-noise amplifiers 1308A-B. A second multi-way switch 1330C is also coupled to multiple antennas (two, in this example) 1304C-D, to a second power amplifier 1356B, and to multiple low-noise amplifiers (two, in this example) 1308C-D. The multi-way switches 1330A and 1330C are configured to allow connection of any associated amplifier in the corresponding module to any associated antenna in the corresponding module, thus allowing both transmission of RF signals and reception of RF signals. In some embodiments, the multi-way switches 1330A and 1330C may include circuitry that functions to separate transmitted and received signals, such as duplexers.

FIG. 13C illustrates 2T4R circuitry 1370 implemented in two modules, a first module 1372 and a second module 1373. The 2T4R circuitry 1370 includes 4 antennas 1304A-D, which are selectively couplable to the TDD and FDD signal paths (1312A-D and 1322A-D) via switching circuitry 1316A-D, respectively. In this embodiment, the modules 1372 and 1373 may be configured with separate SRS switching controls via common control circuitry, or with separate control circuitry operating independently. Each module includes two switches for routing SRS signaling. The first module 1372 includes a first switch 1380A and a second switch 1382A, and the second module 1373 includes a first switch 1380B and a second switch 1382B.

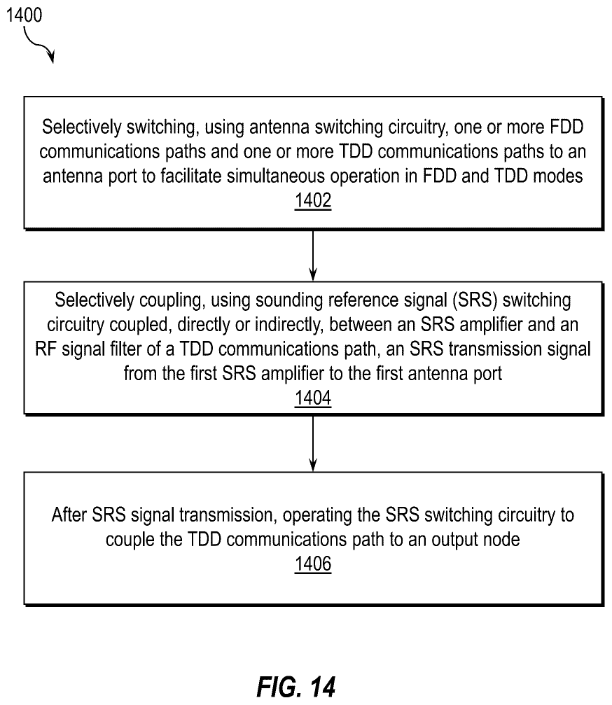

FIG. 14 illustrates an example process 1400, in accordance with one or more embodiments. The example process 1400 may be implemented, for example, using control circuitry for the RF front-end circuitry described with reference to FIGS. 11-13C. In operation 1402, the control circuitry selectively switches, using antenna switching circuitry, one or more FDD communications paths and one or more TDD communications paths to an antenna port to facilitate simultaneous operation in FDD and TDD modes. In operation 1404, the control circuitry selectively couples, using SRS switching circuitry coupled, directly or indirectly, between an SRS amplifier and an RF signal filter of a TDD communications path, an SRS transmission signal from the first SRS amplifier to the first antenna port. In operation 1405, after SRS signal transmission, the control circuitry operates the SRS switching circuitry to couple the TDD communications path to an output node (e.g., to facilitate TDD RX operation).

Further aspects of the present disclosure include the following:

Aspect 1 includes a circuit including a first antenna port; a first plurality of radio frequency (RF) signal paths; first antenna switching circuitry configurable to selectively couple one or more of the first plurality of RF signal paths to the first antenna port; and sounding reference signal (SRS) switching circuitry coupled, directly or indirectly, between an SRS amplifier and one of the first plurality of RF signal paths, the SRS switching circuitry configurable to selectively route an SRS signal from the SRS amplifier to the first antenna port through one of the first plurality of RF signal paths.

Aspect 2 includes the circuit of Aspect 1, further including a second antenna port; a second plurality of RF signal paths; second antenna switching circuitry configurable to selectively couple each of the second plurality of RF signal paths to the second antenna port; and wherein the SRS switching circuitry is further coupled, directly or indirectly, between the SRS amplifier and one of the second plurality of RF signal paths, the SRS switching circuitry configurable to selectively route the SRS signal from the SRS amplifier to the second antenna port through the one of the second plurality of RF signal paths.

Aspect 3 includes the circuit of any of Aspects 1-2, further including a third antenna port; a fourth antenna port; a third plurality of RF signal paths; a fourth plurality of RF signal paths; third antenna switching circuitry configurable to selectively couple each of the third plurality of RF signal paths to the third antenna port; and fourth antenna switching circuitry configurable to selectively couple each of the fourth plurality of RF signal paths to the fourth antenna port; and wherein the SRS switching circuitry is further coupled, directly or indirectly, between the SRS amplifier and one of the third plurality of RF signal paths, the SRS switching circuitry configurable to selectively route the SRS signal from the SRS amplifier to the third antenna port through the one of the third plurality of RF signal paths; and wherein the SRS switching circuitry is further coupled, directly or indirectly, between the SRS amplifier and one of the fourth plurality of RF signal paths, the SRS switching circuitry configurable to selectively route the SRS signal from the SRS amplifier to the fourth antenna port through the one of the fourth plurality of RF signal paths.

Aspect 4 includes the circuit of any of Aspects 1-3, wherein the SRS switching circuitry is configurable, for each of the first plurality of RF signal paths, second plurality of RF signal paths, third plurality of RF signal paths, and fourth plurality of RF signal paths, to selectively couple a corresponding RF signal path to a corresponding low noise amplifier or the SRS signal.

Aspect 5 includes the circuit of any of Aspects 1-4, wherein the SRS switching circuitry comprises multiway switching circuitry coupled between the SRS switching circuitry corresponding to the first plurality of RF signal paths, and the SRS switching circuitry corresponding to the second plurality of RF signal paths, third plurality of RF signal paths, and fourth plurality of RF signal paths, respectively.

Aspect 6 includes the circuit of any of Aspects 1-5, wherein the SRS switching circuitry is configurable to selectively route the SRS signal from the SRS amplifier to the first plurality of RF signal paths or the multiway switching circuitry.

Aspect 7 includes the circuit of any of Aspects 1-6, wherein the circuit includes two or more integrated circuits.

Aspect 8 includes the circuit of any of Aspects 1-7, wherein the SRS switching circuitry includes a hot switch.

Aspect 9 includes the circuit of any of Aspects 1-8, wherein the SRS switching circuitry has a shunt termination impedance to a reference potential and is selectively electrically couplable to one of the first plurality of RF signal paths.

Aspect 10 includes the circuit of any of Aspects 1-9, wherein the first antenna switching circuitry comprises, for each of the first plurality of RF signal paths: a thru switch configured to selectively couple a corresponding RF signal path of the first plurality of RF signal paths to the first antenna port when enabled; and a shunt switch connected to the corresponding one of the first plurality of RF signal paths, the shunt switch configured to isolate the corresponding RF signal path when the thru switch is disabled; and wherein the circuit further comprises timing control circuitry configurable to sequentially activate the shunt switch on a disabled RF signal path and the thru switch on an enabled RF signal path.

Aspect 11 includes a method of operating the circuit of any of Aspects 1-10, including receiving RF signals on the first plurality of RF signal paths; operating, using control circuitry, the SRS switching circuitry to transmit the SRS signal across the first plurality of RF signal paths; and operating, using the control circuitry, the SRS switching circuitry to receive the RF signals via the first plurality of RF signal paths.

Aspect 12 includes a method including selectively switching, using first antenna switching circuitry, each of a first plurality of radio frequency signal paths to a first antenna port, at least one of the first plurality of RF signal paths comprising a first RF signal filter; and selectively coupling, using sounding reference signal (SRS) switching circuitry coupled, directly or indirectly, between an SRS amplifier and the first RF signal filter, an SRS transmission signal from the SRS amplifier to the first antenna port through the first RF signal filter.

Aspect 13 includes the method Aspect 12, further including selectively switching, using second antenna switching circuitry, each of a second plurality of radio frequency signal paths to a second antenna port, at least one of the second plurality of RF signal paths comprising a second RF signal filter; and wherein selectively coupling using the SRS switching circuitry, further comprises selectively routing the SRS transmission signal from the SRS amplifier to the second antenna port through the second RF signal filter.

Aspect 14 includes the method of any of Aspects 12-13, wherein the first plurality of radio frequency signal paths comprises an FDD path and a TDD path; and wherein selectively switching, using first antenna switching circuitry, each of a first plurality of radio frequency signal paths to the first antenna port, further comprises simultaneous operating, through the first antenna port, in both FDD and TDD modes.

Aspect 15 includes a circuit including a plurality of radio frequency (RF) signal paths; a plurality of antenna ports, each antenna port couplable to one or more of the plurality of RF signal paths, including at least one RF signal path having an RF signal filter for processing received signals; and sounding reference signal (SRS) switching circuitry coupled, directly or indirectly, between an SRS amplifier and the at least one RF signal path, the SRS switching circuitry configurable to selectively route an SRS signal from the SRS amplifier to each of the plurality of antenna ports through a corresponding RF signal path.

Aspect 16 includes the circuit of Aspect 15, further including antenna switching circuitry couplable between each antenna port and its corresponding one or more of the plurality of RF signal paths, the antenna switching circuitry configurable to selectively couple the corresponding one or more of the plurality of RF signal paths to the corresponding antenna port to facilitate simultaneous operation in FDD and TDD modes.

Aspect 17 includes the circuit of any of Aspects 15-16 wherein the SRS switching circuitry further comprises, for each antenna port, SRS switching circuitry configurable to selectively couple the corresponding RF signal path between a low noise amplifier and the SRS signal.

Aspect 18 includes the circuit of any of Aspects 15-17, further including multiway switching circuitry coupled between a first SRS switching circuit corresponding to a first of the plurality of antenna ports, and a second SRS switching circuitry coupled to the remaining of the plurality of antenna ports.

Aspect 19 includes the circuit of any of Aspects 15-18, wherein the first SRS switching circuitry is configurable to selectively route the SRS signal from the SRS amplifier to the first of the plurality of antenna ports or the multiway switching circuitry.

Aspect 20 includes the circuit of any of Aspects 15-19, wherein the circuit comprises two or more integrated circuits, each integrated circuit comprising a subset of the RF signal paths and the plurality of antenna ports.

The detailed description set forth above is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using various embodiments.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as non-transitory instructions, program code, and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the present disclosure. It should also be understood that numerous modifications and variations are possible in accordance with the principles of the present disclosure. Accordingly, the scope of the invention is defined only by the following claims.

What is claimed is:

1. A circuit comprising:
a first antenna port;
a first plurality of radio frequency (RF) signal paths;
first antenna switching circuitry configurable to selectively couple one or more of the first plurality of RF signal paths to the first antenna port; and
sounding reference signal (SRS) switching circuitry coupled, directly or indirectly, between an SRS amplifier and one of the first plurality of RF signal paths, the SRS switching circuitry configurable to selectively route an SRS signal from the SRS amplifier to the first antenna port through one of the first plurality of RF signal paths.

2. The circuit of claim 1, further comprising:
a second antenna port;
a second plurality of RF signal paths;
second antenna switching circuitry configurable to selectively couple each of the second plurality of RF signal paths to the second antenna port; and
wherein the SRS switching circuitry is further coupled, directly or indirectly, between the SRS amplifier and one of the second plurality of RF signal paths, the SRS switching circuitry configurable to selectively route the SRS signal from the SRS amplifier to the second antenna port through the one of the second plurality of RF signal paths.

3. The circuit of claim 2, further comprising a third antenna port;
a fourth antenna port;
a third plurality of RF signal paths;
a fourth plurality of RF signal paths;
third antenna switching circuitry configurable to selectively couple each of the third plurality of RF signal paths to the third antenna port; and
fourth antenna switching circuitry configurable to selectively couple each of the fourth plurality of RF signal paths to the fourth antenna port; and
wherein the SRS switching circuitry is further coupled, directly or indirectly, between the SRS amplifier and one of the third plurality of RF signal paths, the SRS switching circuitry configurable to selectively route the SRS signal from the SRS amplifier to the third antenna port through the one of the third plurality of RF signal paths; and
wherein the SRS switching circuitry is further coupled, directly or indirectly, between the SRS amplifier and one of the fourth plurality of RF signal paths, the SRS switching circuitry configurable to selectively route the SRS signal from the SRS amplifier to the fourth antenna port through the one of the fourth plurality of RF signal paths.

4. The circuit of claim 3, wherein the SRS switching circuitry is configurable, for each of the first plurality of RF signal paths, second plurality of RF signal paths, third plurality of RF signal paths, and fourth plurality of RF signal paths, to selectively couple a corresponding RF signal path to a corresponding low noise amplifier or the SRS signal.

5. The circuit of claim 4, further comprising a multiway switching circuitry coupled between the SRS switching circuitry corresponding to the first plurality of RF signal paths, and the SRS switching circuitry corresponding to the second plurality of RF signal paths, third plurality of RF signal paths, and fourth plurality of RF signal paths, respectively.

6. The circuit of claim 5, wherein the SRS switching circuitry is configurable to selectively route the SRS signal from the SRS amplifier to the first plurality of RF signal paths or the multiway switching circuitry.

7. The circuit of claim 1, wherein the circuit comprises two or more integrated circuits.

8. The circuit of claim 1, wherein the SRS switching circuitry comprises a hot switch.

9. The circuit of claim 1, wherein the SRS switching circuitry has a shunt termination impedance to a reference potential and is selectively electrically couplable to one of the first plurality of RF signal paths.

10. The circuit of claim 1, wherein the first antenna switching circuitry comprises, for each of the first plurality of RF signal paths:
a thru switch configured to selectively couple a corresponding RF signal path of the first plurality of RF signal paths to the first antenna port when enabled; and
a shunt switch connected to the corresponding one of the first plurality of RF signal paths, the shunt switch configured to isolate the corresponding RF signal path when the thru switch is disabled; and
wherein the circuit further comprises timing control circuitry configurable to sequentially activate the shunt switch on a disabled RF signal path and the thru switch on an enabled RF signal path.

11. A method of operating the circuit of claim 1, comprising:
receiving RF signals on the first plurality of RF signal paths;
operating, using control circuitry, the SRS switching circuitry to transmit the SRS signal across the first plurality of RF signal paths; and
operating, using the control circuitry, the SRS switching circuitry to receive the RF signals via the first plurality of RF signal paths.

12. A method comprising:
selectively switching, using first antenna switching circuitry, each of a first plurality of radio frequency signal paths to a first antenna port, at least one of the first plurality of RF signal paths comprising a first RF signal filter; and
selectively coupling, using sounding reference signal (SRS) switching circuitry coupled, directly or indirectly, between an SRS amplifier and the first RF signal filter, an SRS transmission signal from the SRS amplifier to the first antenna port through the first RF signal filter.

13. The method of claim 12, further comprising:
selectively switching, using second antenna switching circuitry, each of a second plurality of radio frequency signal paths to a second antenna port, at least one of the second plurality of RF signal paths comprising a second RF signal filter; and
wherein selectively coupling using the SRS switching circuitry, further comprises selectively routing the SRS transmission signal from the SRS amplifier to the second antenna port through the second RF signal filter.

14. The method of claim 12, wherein the first plurality of radio frequency signal paths comprises an FDD path and a TDD path; and
wherein selectively switching, using first antenna switching circuitry, each of a first plurality of radio frequency signal paths to the first antenna port, further comprises simultaneous operating, through the first antenna port, in both FDD and TDD modes.

15. A circuit comprising:
a plurality of radio frequency (RF) signal paths;
a plurality of antenna ports, each antenna port couplable to one or more of the plurality of RF signal paths, including at least one RF signal path having an RF signal filter for processing received signals; and
sounding reference signal (SRS) switching circuitry coupled, directly or indirectly, between an SRS amplifier and the at least one RF signal path, the SRS switching circuitry configurable to selectively route an SRS signal from the SRS amplifier to each of the plurality of antenna ports through a corresponding RF signal path.

16. The circuit of claim 15 further comprising:
antenna switching circuitry couplable between each antenna port and its corresponding one or more of the plurality of RF signal paths, the antenna switching circuitry configurable to selectively couple the corresponding one or more of the plurality of RF signal paths to the corresponding antenna port to facilitate simultaneous operation in FDD and TDD modes.

17. The circuit of claim 16, wherein the SRS switching circuitry further comprises, for each antenna port, SRS switching circuitry configurable to selectively couple the corresponding RF signal path between a low noise amplifier and the SRS signal.

18. The circuit of claim 17, further comprising multiway switching circuitry coupled between a first SRS switching circuit corresponding to a first of the plurality of antenna ports, and a second SRS switching circuitry coupled to the remaining of the plurality of antenna ports.

19. The circuit of claim 18, wherein the first SRS switching circuitry is configurable to selectively route the SRS signal from the SRS amplifier to the first of the plurality of antenna ports or the multiway switching circuitry.

20. The circuit of claim 15 wherein the circuit comprises two or more integrated circuits, each integrated circuit comprising a subset of the RF signal paths and the plurality of antenna ports.
